(19) United States
(12) Patent Application Publication
(10) Pub. No.: US 2026/0310507 A1
(43) Pub. Date: Oct. 8, 2026

(54) DQN-BASED TASK PLANNING

(71) Applicant: Dell Products L.P., Round Rock, TX (US)

(72) Inventors: Eduardo Vera SOUSA, Niterói (BR); Karen Stéfany Martins Zuin, Belo Horizonte (BR)

(21) Appl. No.: 19/169,384

(22) Filed: Apr. 3, 2025

(51) Int. Cl. G06F 9/50

(52) U.S. Cl. CPC G06F 9/5027

(57) ABSTRACT

One example method includes receiving a mission in natural language format, which specifies an action to be executed by an agent on behalf of a user. A first embedding operation is performed on the mission to create a first vector representation. From a pool of tasks, a first task is selected for the agent to execute the mission. A second embedding operation generates a second vector representation of this task, while a third embedding operation produces a third vector representation of the task's execution order. These vector representations are concatenated to form a single vector. A machine learning model then utilizes this concatenated vector to generate a task plan. This plan details the first task and its execution order, along with additional tasks and their respective execution orders, guiding the agent in mission completion.

### TECHNOLOGICAL FIELD OF THE DISCLOSURE

Embodiments disclosed herein generally relate to task planning and orchestration. More particularly, at least some embodiments relate to systems, hardware, software, computer-readable media, and methods that implement a Deep Q-Network (DQN) for task planning and orchestration.

### BACKGROUND

Agents are able to accomplish tasks through self-directed planning and actions. Most recent planning solutions for agents are based on Large Language Models (LLMs) due to the capacity of LLMs for extracting tasks from user input and mapping the tasks to available tools for performing the action. However, as the number of tasks increases, there has been a corresponding increase in the hallucination rate by the LLMs. Depending on the application, those hallucinations can affect the reliability of the planning solutions. In addition, LLMs generally have high computational cost when compared to other solutions, sometimes demanding specific hardware in order to run in a feasible time.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an agent that performs a user defined mission according to the embodiments disclosed herein.

FIGS. 2A-2C disclose aspects of a planning module including a DQN model during a training phase according to the embodiments disclosed herein.

FIG. 3 discloses aspects of task pool indexing according to the embodiments disclosed herein.

FIG. 4 discloses aspects of plan task indexing according to the embodiments disclosed herein.

FIG. 5 discloses aspects of generating the concatenated vector according to the embodiments disclosed herein.

FIG. 6 discloses disclose aspects of a planning module including a DQN model during an inference phase according to the embodiments disclosed herein.

FIG. 7 discloses aspects of a method according to the embodiments disclosed herein.

FIG. 8 discloses a computing entity configured and operable to perform any of the disclosed methods, processes, and operations.

### DETAILED DESCRIPTION OF SOME EXAMPLE EMBODIMENTS

Embodiments disclosed herein generally relate to task planning and orchestration. More particularly, at least some embodiments relate to systems, hardware, software, computer-readable media, and methods that implement a Deep Q-Network (DQN) for task planning and orchestration.

In some aspects, the embodiments disclosed herein relate to a method that includes receiving a mission in natural language format, which defines an action to be performed by an agent on behalf of a user. The method involves generating vector representations of the mission and tasks, selecting tasks from a pool, and using a machine learning model to create a task plan that lists the tasks and their order for the agent to perform the mission.

In particular, at least one embodiment disclosed herein relates to a method, including: receiving a mission that defines an action that is to be performed by an agent on behalf of a user, the mission being received in a natural language format; performing a first embedding operation on the received mission to generate a first vector representation of the received mission; selecting, from a pool of tasks, a first task that is to be performed by agent when performing the mission; performing a second embedding operation on the first task to generate a second vector representation of the first task; performing a third embedding operation to generate a third vector representation of an order that the first task is to be performed by agent when performing the mission; concatenating the first, second, and third vector representations to generate a concatenated vector; and generating, by a machine learning (ML) model, based on the concatenated vector, a task plan that lists the first task in the order that the first task is to be performed by the agent when performing the mission, wherein the task plan also lists one or more additional tasks and the order that the one or more additional tasks are to be performed by the agent when performing the mission.

At least one embodiment disclosed herein relates to a non-transitory storage medium having stored therein instructions that are executable by one or more hardware processors to perform operations including: receiving a mission that defines an action that is to be performed by an agent on behalf of a user, the mission being received in a natural language format; performing a first embedding operation on the received mission to generate a first vector representation of the received mission; selecting, from a pool of tasks, a first task that is to be performed by agent when performing the mission; performing a second embedding operation on the first task to generate a second vector representation of the first task; performing a third embedding operation to generate a third vector representation of an order that the first task is to be performed by agent when performing the mission; concatenating the first, second, and third vector representations to generate a concatenated vector; and generating, by a machine learning (ML) model, based on the concatenated vector, a task plan that lists the first task in the order that the first task is to be performed by the agent when performing the mission, wherein the task plan also lists one or more additional tasks and the order that the one or more additional tasks are to be performed by the agent when performing the mission.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, the embodiments disclosed herein provide a reliable framework for task planning based on a DON, which presents high accuracy even for a variable number of tasks in the plan. The embodiments disclosed herein are accurate even for larger action spaces, which is an improvement over LLM based orchestrators that are prone to hallucinating as the number of possible tasks increases. The embodiments disclosed herein provide for reduced computational costs for the planning orchestration processes, enabling the framework to run even without specialized hardware such as a GPU.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

At least some of the embodiments disclosed herein may implement one or more machine learning (ML) models. As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

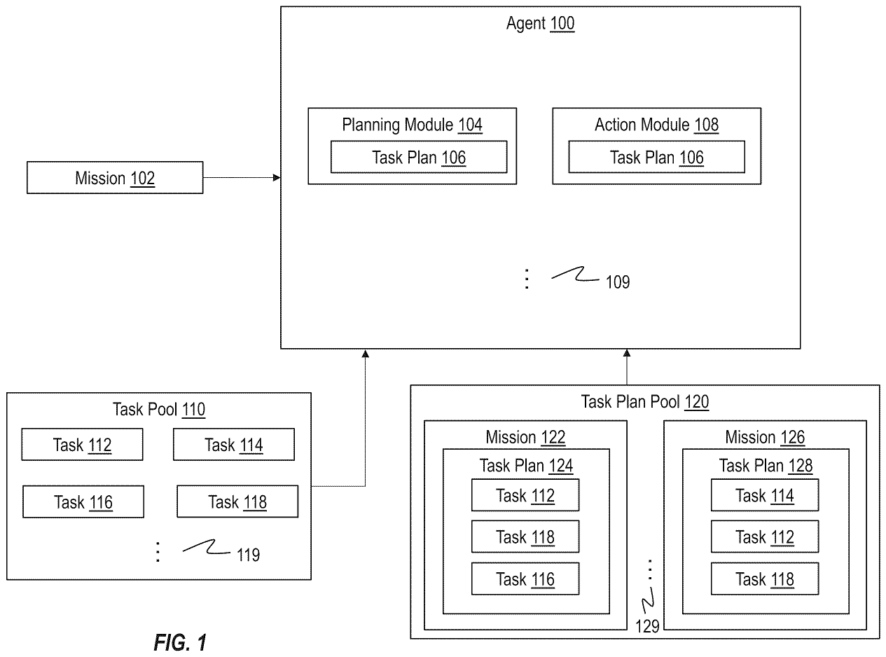

FIG. 1 illustrates an agent 100 according to the embodiments disclosed herein. In operation, the agent 100 is able to perform a user defined mission. The user desired mission specifies a specific action that the user desires the agent 100 to accomplish. Accordingly, the agent 100 receives a mission 102 from the user that specifies the action that the user desires the agent 100 to accomplish. The mission 102 is typically input as a real or natural language text or audio input. For example, suppose the user wanted to generate speech audio from text and then classify emotions found in the speech, then the mission 102 in one example embodiment may be “I would like to generate an enhanced speech audio of the text ‘I am feeling really sad today. I wish I could understand why.’ and classify the emotions expressed in this speech.”

The mission 102 is input into a planning module 104 of the agent 100. As will be explained in more detail to follow, the planning module 104 implements one or more ML models to generate a task plan 106 that includes a listing of tasks needed to accomplish the user desired mission and the order that the tasks should be performed in. For example, given the example embodiment of the mission 102 discussed previously, the planning module 104 would include in the task plan 106 tasks such as text-to-speech conversion, audio enhancement, and emotion classification as tasks and would also include in the task plan 106 the order that these tasks should be performed in order to generate speech audio from text and then classify emotions found in the speech.

The task plan 106 is then used by an action module 108 of the agent 100 to perform the mission specified in the mission 102. The action module 108 includes all the hardware and/or software, including needed ML models, that the agent 100 needs to perform the mission specified in the mission 102 according to the task plan 106. Thus, for the example embodiment discussed previously, the action module 108 would include all the hardware and/or software needed to generate speech audio from text and then classify emotions found in the speech. In some embodiments, the agent 100 can include additional modules 109 such as profile modules and storage modules as illustrated by the ellipses.

In order to generate the task plan 106, the planning module 104 has accesses to a task pool 110. In some embodiments, the task pool 110 can be part of the agent 100 and stored in a storage module and in other embodiments the task pool 110 is separate from, but accessible by, the planning module 104. The task pool 110 stores various tasks that are to be performed in order to accomplish the user mission. As illustrated, the task pool 110 includes a task 112, a task 114, a task 116, a task 118, and any number of additional tasks 119 as illustrated by the ellipses. In the embodiments, the tasks 112, 114, 116, 118, and 119 are an abstraction of a method, including the required hardware and/or software resources, that are needed to perform the task. Thus, for example, if the task 112 was a text-to-speech conversion task, then the task 112 would include the method needed to perform text-to-speech conversion. In some embodiments the tasks 112, 114, 116, 118, and 119 include, but are not limited to, token classification, translation, summarization, question answering, conversational, text generation, sentence similarity, tabular classification, object detection, image classification, image-to-image conversion, image-to-text conversion, text-to-image conversion, text-to-video conversion, visual question answering, document questioning answering, image segmentation, depth estimation, text-to-speech conversion, automatic speech recognition, audio-to-audio conversion, audio classification, and image editing. Thus, the embodiments disclosed herein are not limited by the particular set of tasks included in the task pool 110.

In order to train the planning module 104, as will be explained in more detail to follow, the planning module 104 has accesses to a task plan pool 120. In some embodiments, the task plan pool 120 can be part of the agent 100 and stored in a storage module and in other embodiments the task plan pool 120 is separate from, but accessible by, the planning module 104. The task plan pool includes various user missions and an associated task plan that includes that includes a listing of tasks needed to accomplish the each mission and the order that the tasks should be performed in. As illustrated, the task plan pool includes a mission 122 and it associated task plan 124, a mission 126 and its associated task plan 128, and any number of additional missions 129 and their associated task plans as illustrated by the ellipses.

The mission 122 is associated with the task plan 124. The task plan 124 specifies that in order to accomplish the mission 122, the tasks 112, 116, and 118 need to be performed and that task 112 needs to be performed first, task 118 needs to be performed second, and task 116 needs to be performed last. Likewise, the mission 126 is associated with the task plan 128. The task plan 128 specifies that in order to accomplish the mission 126, the tasks 112, 114, and 118 need to be performed and that task 114 needs to be performed first, task 112 needs to be performed second, and task 118 needs to be performed last. It will be appreciated that although task plans 124 and 128 are shown as having only three tasks, this is for ease of illustration only as the task plans can include any number of tasks, the number being determined by the number of tasks needed to accomplish the mission associated with the task plan.

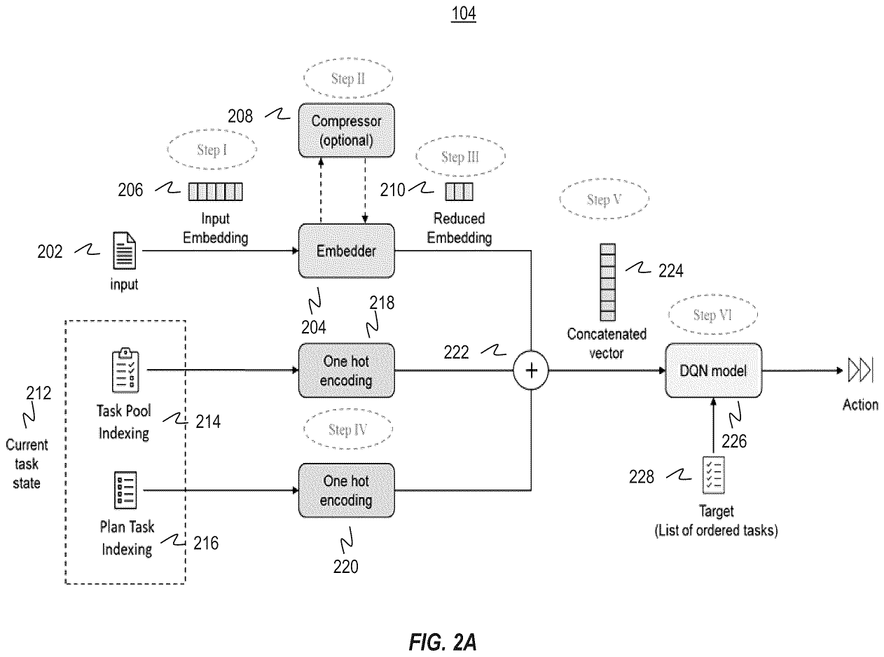

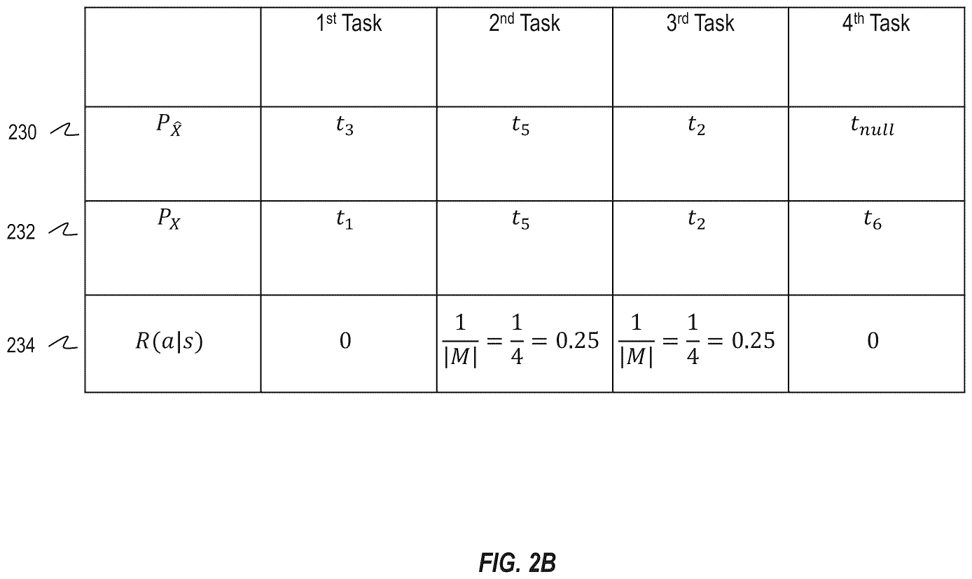

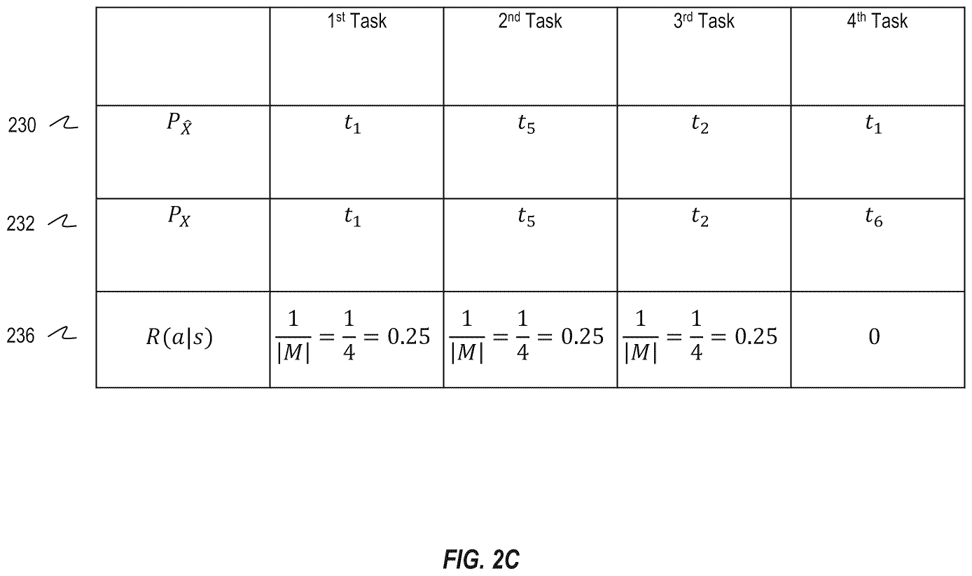

FIG. 2A illustrates an embodiment of the planning module 104 while in a training phase. In the training phase, every time the environment is reset, a mission 202 and its associated task plan are randomly selected from the task plan pool 120. The mission 202 is input into the planning module 104 and its associated task plan is used during the training as a ground truth target as will be explained. Thus, the mission 202 can correspond to one of the missions 122, 126, or 129. As previously described, the mission 202 is input in natural language like “I have a table in example .jpg and need to know how many times the term ‘COVID-19’ is mentioned. Can you help?”

During a first training step, an embedder 204, which in some embodiments is an LLM embedding model, generates an input embedding 206 from the input mission 202. Since the input embedding 206 may have high dimensionality, in some embodiments the input embedding 206 is provided to a compressor 208 during a second training step.

In one embodiment, the compressor 208 is a feature extraction neural network with less neurons on the output layer than the input layer. Thus, the compressor 208 receives the input embedding 206 that passes through a neural network until the compressor's last layer, where the compressor 208 outputs a reduced input embedding 210 during a third training step. The compressor 208 ensures that only the k most relevant features for the completeness of the mission 202 are kept in the reduced input embedding 210, where k is the number of output neurons in the compressor 208. Thus, the compressor 208 works in a similar manner to an autoencoder but, while an autoencoder keeps the most relevant features for the data reconstruction, the compressor 208 only keeps only the k most relevant features for task prediction. It will be appreciated that the use of the compressor 208 to generate the reduced input embedding 210 during the second and third training steps need not be performed in every embodiments as in some embodiments the input embedding 206 can be used during the training phase without the need for any compression.

At a fourth training step, a current task state 212 is determined using task pool indexing 214 and plan task indexing 216. During the task pool indexing 214, a task from the task pool 110 is randomly selected and then encoded using one-hot encoding 218 into a n-dimensional vector that encodes which task from the task pool 110 is being randomly selected. During the plan task indexing 216 the randomly selected task is encoded using one-hot encoding 220 into a m-dimensional vector that encodes where the randomly selected task is placed or located in the task plan. An all zero vector can also be randomly produced for the task pool indexing 214 and plan task indexing 216, which represents an initial state where no task has been selected yet.

One reason why the task position is randomly selected in the task plan instead of only selecting the task and adding it sequentially to the task plan comes from the fact that the beginning of the sequence would correspond to an exploration phase of reinforcement learning (RL) training while the end of the sequence would be more conservative due to exploitation phase. This makes the task selection at the end of the planning more prune to errors, particularly tasks related to a tₙᵤₗₗ or other tasks that are commonly located at the end of a mission plan in the dataset, due to the lack of exploration in the later training stages. This potential problem is overcome by randomly selecting the index at each step.

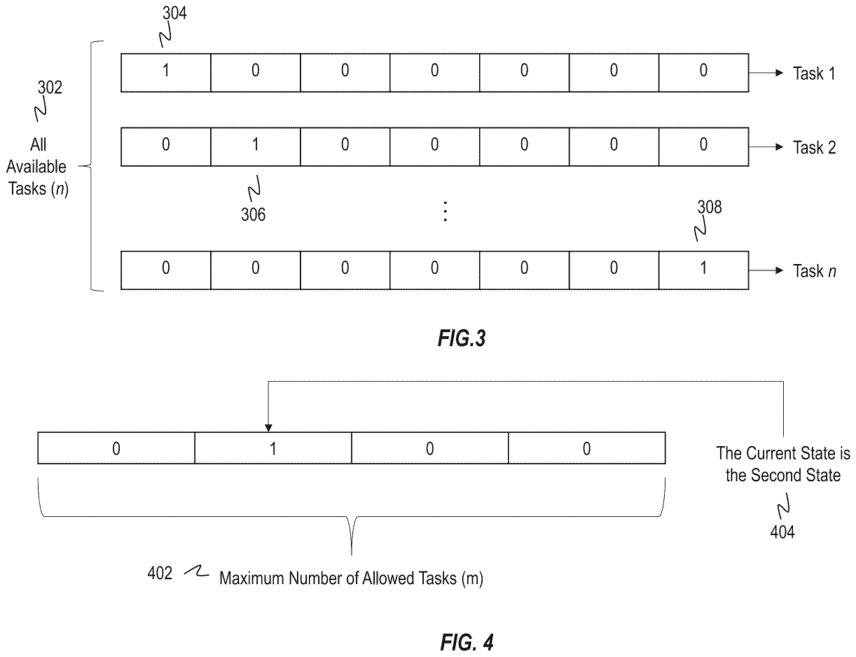

Task pool indexing and plan task indexing, such as task pool indexing 214 and plan task indexing 216 (and task pool indexing 614 and plan task indexing 616 that will be explained in more detail to follow), will now be explained in more detail. During task pool indexing, one-hot encoding is used to represent each available task of the task pool 110 as a n-dimensional vector. In this scenario, as shown in FIG. 3 at 302, all the available tasks in the tasks n in the task pool 110 are represented by an n-dimensional vector. Thus, for a task pool 110 having seven available tasks, task t₁ is represented at 304 by [1, 0, 0, 0, 0, 0, 0], task t₂ is represented at 306 by [0, 1, 0, 0, 0, 0, 0], task t₃ is represented by [0, 0, 1, 0, 0, 0, 0], task t₃ is represented by [0, 0, 0, 1, 0, 0, 0], task t₅ is represented by [0, 0, 0, 0, 1, 0, 0], task t₆ is represented by [0, 0, 0, 0, 0, 1, 0], and task n, which is task t₇ in the embodiment, is represented at 308 by [0, 0, 0, 0, 0, 0, 1].

Plan task indexing uses one-hot encoding to produce a vector representation of the order or placement or location of the tasks in the task plan. For example, as previously described, the sequence of tasks needed to complete a given user mission is the task plan. A task plan for a user mission X that runs the tasks t₃, t₅ and t₂, for example, could be formally described by:

$${P}_{X} = \{ {t}_{3} , {t}_{5} , {t}_{2} \}$$

It will be appreciated that the tasks of a task plan should be executed in the correct order to complete the user mission, which implies that the index of each task in the task plan is important. Thus, the index of task t₃ in the mission X can be represented by a one-hot encoding of its position in the task plan. As t₃ is the first element in the sequence, it is indexed by:

$$I ( {t}_{3} , {P}_{X} ) = [ 1 , 0 , 0 ]$$

Similarly, as t₅ is the second element in the sequence, it is indexed by:

$$I ( {t}_{5} , {P}_{X} ) = [ 0 , 1 , 0 ]$$

Finally, as t₂ is the second element in the sequence, it is indexed by:

$$I ( {t}_{2} , {P}_{X} ) = [ 0 , 0 , 1 ]$$

Thus, while the task pool indexing shows which tasks are being referred to, plan task indexing is a one-hot encoding that refers to the position (index) of a given task in the task plan, considering that there is a maximum number of allowed tasks m. FIG. 4 illustrates an example of plan task indexing. As illustrated at 402, there is a maximum number of allowed tasks m in the task plan, which is four in the embodiment of FIG. 4. FIG. 4 also illustrates at 404 that the current state is the second state, meaning that the selected task is in the second position in the task plan.

The embodiments disclosed herein implement a fixed number of tasks m in the task plan. However, if the user mission requires a number of tasks smaller than m, a flag task, which is called a null task, is used to indicate that the task plan is completely built, and no other task needs to be included. Thus, every time the planning module 104 selects a null task, it corresponds to the end of a training phase or an inference phase. It is important to notice that this task is also available for selection in the task pool 110, so it is also one-hot encoded.

In summary:
Task pool indexing: n-dimensional vector that encodes which task from the task pool 110 is being selected.
Plan task indexing: m-dimensional vector that encodes where the task is located in the task plan.

Returning to FIG. 2A, the n-dimensional vector that encodes which task from the task pool 110 is being selected generated by the one-hot encoding 218 and the m-dimensional vector that encodes where the task is located in the task plan generated by the one-hot encoding 220 are provided to a concatenator 222 in a fifth training step. In addition, the input embedding 206 or the reduced input embedding 210 in the embodiments implementing the compressor 208 are also provided to the concatenator 222 in the fifth training step. The concatenator 222 concatenates the input embedding 206 or reduced input embedding 210, the n-dimensional vector that encodes which task from the task pool 110 is being selected, and the m-dimensional vector that encodes where the task is located in the task plan into a single concatenated vector 224, which can be referred to as a reinforcement learning (RL) state.

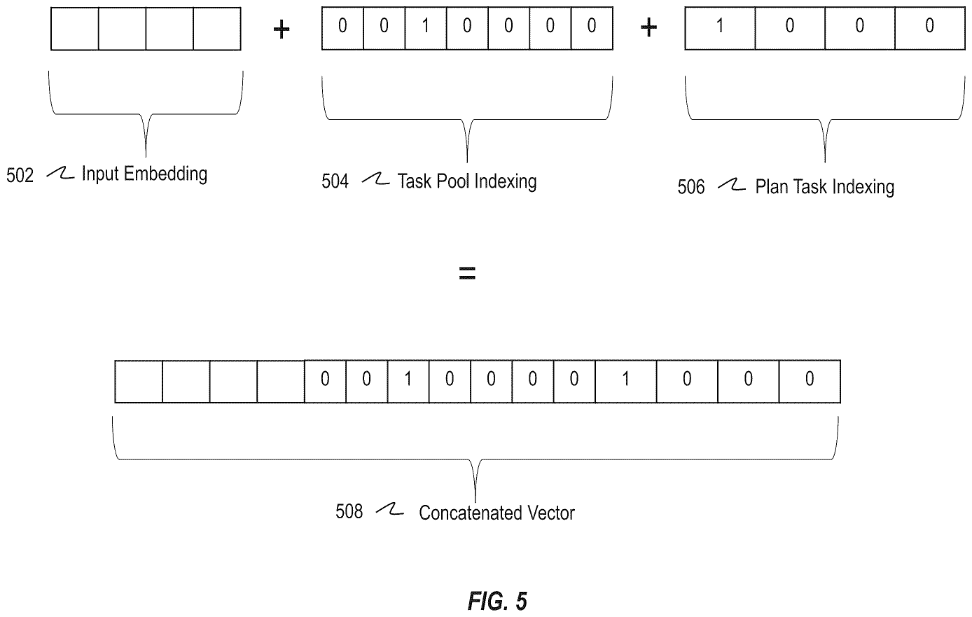

FIG. 5 illustrates the process of generating the concatenated vector 224. As illustrated, an input embedding 502, which corresponds to either input embedding 206 or reduced input embedding 210, a n-dimensional vector 504 that encodes which task from the task pool 110 is being selected using task pool indexing, and a m-dimensional vector 506 that encodes where the task is located in the task plan using plan task indexing are concatenated to generate a concatenated vector 508, which corresponds to the concatenated vector 224. In the figure, the vector 504 shows that the third task has been selected and the vector 506 shows that the third task has been placed as the first task in the task plan. Thus, while the mission embedding 502 is fixed for a given mission, the vectors 504 and 506 change as the reinforcement learning state advances. That is, as the reinforcement learning state advances from one state to the next, the task pool indexing will result in a vector 504 having a different selected task and the plan task indexing will result in the vector 506 having the different selected task in a different position in the task plan. It is noted that this does not impacts the Markovian property of the reinforcement learning algorithms, as the previous selections of task pool indexing, and plan task indexing does not impact on future selections.

Returning to FIG. 2A, at a sixth training step the concatenated vector 224 is input into a Deep Q-Network (DQN) model 226. The DON model 226 is then trained by a supervised reinforcement learning process. The supervised reinforcement learning process is considered “supervised learning” because the DON model 226 is provided with a known task plan 228 for the input mission 202. As previously discussed, the task plan pool 120 includes missions and their associated task plans. Thus, the known task plan 228 corresponds to the task plan of the mission that was randomly selected as the mission 202. For example, if the mission 122 was randomly selected to be the mission 202, then the known task plan 228 would correspond to the task plan 124.

During the supervised reinforcement learning process, the DON model 226 determines, for the given state specified by the concatenated vector 224, where a given task of the input mission 202 should be placed in the task plan to maximize an overall reward. In other words, the DON model 226 maximizes the reward when a task specified by the concatenated vector 224 matches the location of the same task in the known task plan 228.

In some embodiments, the reward function is given by:

$$R ( a \vert s ) = \{ \begin{matrix}\frac{1}{\vert M \vert} , & if the selected task is equals to the ground - truth \\ 0 & otherwise\end{matrix}$$

where |M| corresponds to the sequence length of a mission. This provides a fair reward, regardless the length of the sequence. The supervised learning process continues for each randomly selected mission 202 until the DON model 226 is sufficiently trained to know which tasks and their required order in the task plan are associated with each mission 202.

FIGS. 2B and 2C illustrate the supervised reinforcement learning process for the DON model 226. As illustrated, the task planning for a mission X, represented by P_{\hat{X}} when compared to its known task plan 228, represented by P_{X} in the figures. In the figures, |M|=4 and the reward (last row) would be 0.25 whenever a task in P_{\hat{X}} is equals to a task in P_{X} and 0 otherwise.

In FIG. 2B, which shows the learning process during a first training episode, P_{X} 230 includes task t₃ as a first task, task t₅ as a second task, task t₂ as a third task, and task tₙᵤₗₗ as a fourth task and P_{X} 232 includes t₁ as a first task, task t₅ as a second task, task t₂ as a third task, and task to as a fourth task. Thus, as shown at 234, the values of the second and third tasks are equal to each other and a reward of 0.25 is given for each matched task, leading to a total reward of 0.5.

In FIG. 2C, which shows the learning process during a subsequent training episode, P_{\hat{X}} 230 now includes task t₁ as a first task, task t₅ as a second task, task t₂ as a third task, and task t as a fourth task and P_{X} 232 remains the same. In this training episode, as shown at 236, the first tasks, in addition to the second and third tasks, are now equal to each other and a reward of 0.25 is given for each matched task, leading to a total reward of 0.75, which is higher than total reward of 0.5 during the first training episode. Thus, the DON model 226 has further maximized the total reward in the subsequent training episode over the first training episode. The process will continue until the DON model 226 is able to match the values of the fourth task to obtain the highest maximum reward possible.

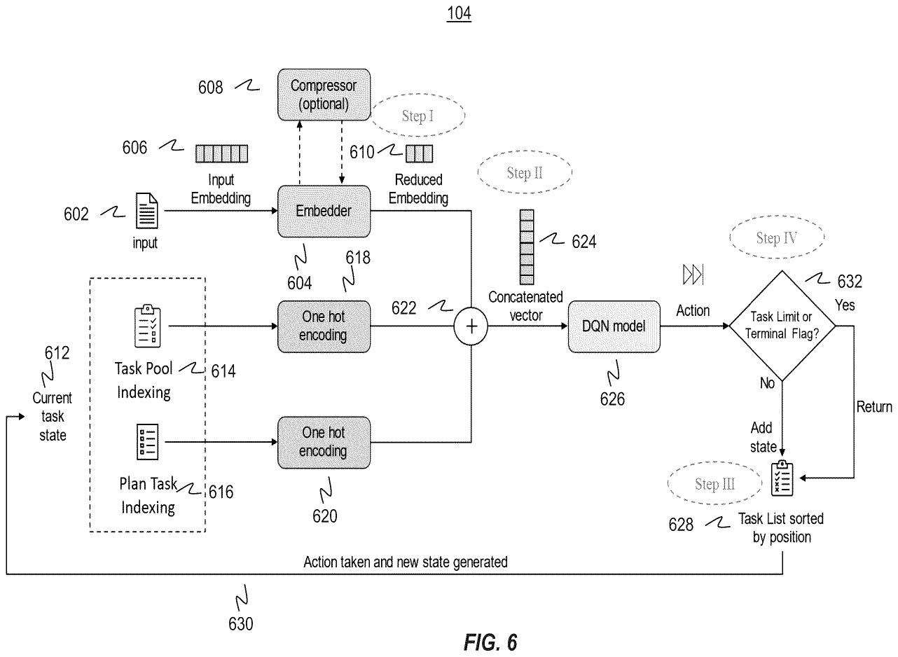

Having described the training phase, an embodiment of an inference phase of the planning module 104 will now be explained in relation to FIG. 6. In the inference phase, a user mission 602 is input into the planning module 104. As with the other user missions previously discussed, the user mission 602 specifies a specific action that the user desires the agent 100 to accomplish. The user mission 602 is typically input as a real language text or audio input. The user mission 602 is input into the planning module 104.

During a first inference step, an embedder 604, which in some embodiments is an LLM embedding model, generates an input embedding 606 from the input user mission 602. Since the input embedding 606 may have high dimensionality, in some embodiments the input embedding 606 is provided to a compressor 608, which corresponds to and operates in the same manner as previously described in relation to compressor 208. Accordingly, in the embodiments that implement the compressor 608, a reduced input embedding 610 is generated.

In addition, during the first inference step the a current task state 612 is determined using task pool indexing 614 and plan task indexing 616 that function in the same manner as the task pool indexing 214 and plan task indexing 216 previously described. Initially, the task pool indexing 614 generates a vector of all zeros and the plan task indexing also generates a vector of all zeros, which is used to indicate that the agent 100 is in an initial state where no tasks have been added.

At a second inference state 2, the concatenator 622, which corresponds to the concatenator 222 concatenates the all zero vectors with the input embedding 606 or the reduced input embedding 610 to generate a concatenated vector 624, which corresponds to the concatenated vector 224, and which is the current RL state. The concatenated vector 624 is then input into a trained DQN model 626, which corresponds to the DON model 226 previously described.

During a third inference step, the trained DON model 626 adds the task specified in the concatenated vector 624 to a task plan 628 in the position specified by the concatenated vector 624. In the initial state, however, no task is added since the concatenated vector 624 includes only zeros for the task and task position. At a fourth inference step, a new state is generated by the trained DON model 626 as shown at 630 based on the next task that the trained DQN model 626 predicts should be included based on the user mission 602.

Thus, after the initial state the trained DON model 626 will predict a task of the task pool 110 that should be performed first so that the user mission 602 can be accomplished. Accordingly, this first task is encoded using one-hot encoding 618 into a n-dimensional vector during task pool indexing 614. During the plan task indexing 616 the first task is encoded using one-hot encoding 620 into a m-dimensional vector that encodes the order where the first task should be placed or located in the task plan.

The concatenator 622 then concatenates the n-dimensional vector that encodes the first task from the task pool 110, the m-dimensional vector that encodes where the first task should be placed or located in the task plan, and the input embedding 606 or the reduced input embedding 610 in the embodiments implementing the compressor 208 into the single concatenated vector 624, which is the current RL state.

The trained DON model 626 adds the first task specified in the concatenated vector 624 to a task plan 628 in the first position and a new state is generated by the trained DQN model 626 as shown at 630 based on the next task that the trained DQN model 626 predicts should be included based on the user mission 602. In this case, the next task would be a task of the task pool 110 that should be performed second so that the user mission 602 can be accomplished. The process is repeated so that the second task is added to the task plan 628.

A new state for task of the task pool 110 that should be performed third so that the user mission 602 can be accomplished is then generated and the process is repeated so that the third task is added to the task plan 628 and so on until, as shown at 632, a terminal task flag (tₙᵤₗₗ) is inserted into the task plan 628 or the task plan 628 reaches its maximum length m.

The generated task plan 628, which corresponds to the task plan 106, is then provided to the action module 108. The action module 108 performs the various tasks in the order specified by the task plan 628 to accomplish the user mission 602.

### Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

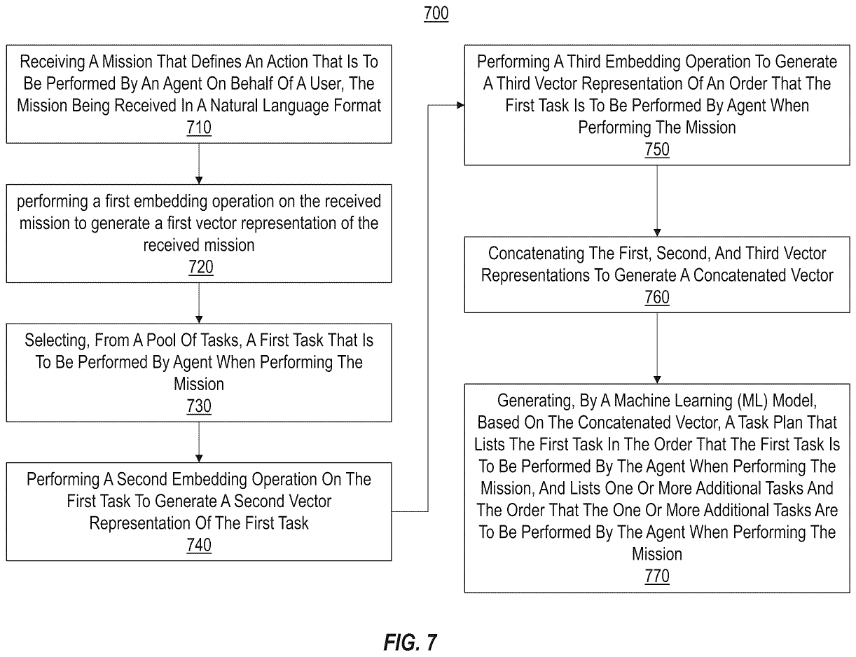

Directing attention now to FIG. 7, an example method 700 is disclosed. The method 700 will be described in relation to one or more of the figures previously described, although the method 700 is not limited to any particular embodiment.

The method 700 includes receiving a mission that defines an action that is to be performed by an agent on behalf of a user, the mission being received in a natural language format (710). For example, as previously described the planning module 104 receives the mission 602 in a natural language format. The mission 602 defines an action that the agent 100 is to perform on behalf of the user.

The method 700 includes performing a first embedding operation on the received mission to generate a first vector representation of the received mission (720). For example, as previously described the embedder 604 generates the input embedding 606. In some embodiments, the compressor 608 is implemented to generate the reduced input embedding 610.

The method 700 includes selecting, from a pool of tasks, a first task that is to be performed by agent when performing the mission (730). For example, as previously described a first task is selected from the task pool 110.

The method 700 includes performing a second embedding operation on the first task to generate a second vector representation of the first task (740). For example, as previously described the first task is encoded using one-hot encoding 618 into a n-dimensional vector during task pool indexing 614.

The method 700 includes performing a third embedding operation to generate a third vector representation of an order that the first task is to be performed by agent when performing the mission (750). For example, as previously described during the plan task indexing 616 the first task is encoded using one-hot encoding 620 into a m-dimensional vector that encodes the order where the first task should be placed or located in the task plan 628.

The method 700 includes concatenating the first, second, and third vector representations to generate a concatenated vector (760). For example, as previously described the concatenated vector 624 is generated in manner disclosed herein.

The method 700 includes generating, by a machine learning (ML) model, based on the concatenated vector, a task plan that lists the first task in the order that the first task is to be performed by the agent when performing the mission, wherein the task plan also lists one or more additional tasks and the order that the one or more additional tasks are to be performed by the agent when performing the mission (770). For example, as previously described the DQN model 626 generates the task plan 628 by listing the tasks and their execution order that are needed to perform the user mission 602.

### FURTHER EXAMPLE EMBODIMENTS

Following are some further example embodiments of the invention. These are presented only by way of example and are not intended to limit the scope of the invention in any way.

Embodiment 1. A method comprising: receiving a mission that defines an action that is to be performed by an agent on behalf of a user, the mission being received in a natural language format; performing a first embedding operation on the received mission to generate a first vector representation of the received mission; selecting, from a pool of tasks, a first task that is to be performed by the agent when performing the mission; performing a second embedding operation on the first task to generate a second vector representation of the first task; performing a third embedding operation to generate a third vector representation of an order that the first task is to be performed by agent when performing the mission; concatenating the first, second, and third vector representations to generate a concatenated vector; and generating, by a machine learning (ML) model, based on the concatenated vector, a task plan that lists the first task in the order that the first task is to be performed by the agent when performing the mission, wherein the task plan also lists one or more additional tasks and the order that the one or more additional tasks are to be performed by the agent when performing the mission.

Embodiment 2. The method as recited in embodiment 1, further comprising: selecting, from the pool of tasks, a second task that is to be performed by the agent when performing the mission; performing a fourth embedding operation on the second task to generate a fourth vector representation of the second task; performing a fifth embedding operation to generate a fifth vector representation of an order that the second task is to be performed by agent when performing the mission; and concatenating the first, fourth, and fifth vector representations to generate a second concatenated vector, wherein the ML model, based on the second concatenated vector, lists in the task plan the second task in the order that the second task is to be performed by the agent when performing the mission, the second task being one of the one or more additional tasks.

Embodiment 3. The method as recited in any of embodiments 1-2, further comprising: performing, by the agent, the mission by performing all the tasks listed in the task plan in the order that the tasks are listed in the task plan.

Embodiment 4. The method as recited in any of embodiments 1-3, further comprising: compressing the first vector representation of the received mission to generate a reduced first vector representation.

Embodiment 5. The method as recited in any of embodiments 1-4, wherein the ML model is configured to be trained using a supervised reinforcement learning process.

Embodiment 6. The method as recited in any of embodiments 1-5, wherein the ML model is a Deep Q-Network (DQN) model.

Embodiment 7. The method as recited in any of embodiments 1-6, wherein the first embedding operation is performed by a large language model.

Embodiment 8. The method as recited in any of embodiments 1-7, wherein at least one of the second and third embedding operations is a one-hot encoding operation.

Embodiment 9. The method as recited in embodiment 8, wherein the ML model ceases to generate the task plan upon receiving a null task.

Embodiment 10. The method as recited in any of embodiments 1-9, wherein the ML model ceases to generate the task plan when a number of tasks including the first task and the one or more additional tasks listed in the task plan reaches a maximum length needed to perform the mission.

Embodiment 11. A computing system for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-11.

### Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

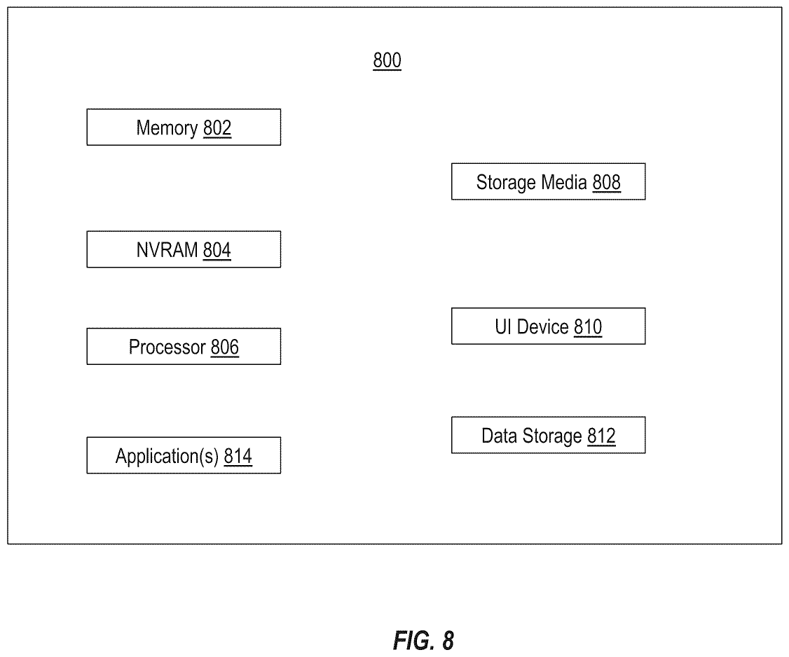

With reference briefly now to FIG. 8, any one or more of the entities disclosed, or implied, by FIGS. 1-7 and/or elsewhere herein, may take the form of, or include, or be implemented on, or hosted by, a physical computing device, one example of which is denoted at 800. As well, where any of the aforementioned elements comprise or consist of a virtual machine (VM), that VM may constitute a virtualization of any combination of the physical components disclosed in FIG. 8.

In the example of FIG. 8, the physical computing device 800 includes a memory 802 which may include one, some, or all, of random access memory (RAM), non-volatile memory (NVM) 804 such as NVRAM for example, read-only memory (ROM), and persistent memory, one or more hardware processors 806, non-transitory storage media 808, UI device 810, and data storage 812. One or more of the memory 802 components of the physical computing device 804 may take the form of solid state device (SSD) storage. As well, one or more applications 814 may be provided that comprise instructions executable by one or more hardware processors 806 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The described embodiments are to be considered in all respects only as illustrative and not restrictive. All changes which come within the meaning and range of equivalency of the claims are to be embraced within their scope.

What is claimed is:

1. A method, comprising:
receiving a mission that defines an action that is to be performed by an agent on behalf of a user, the mission being received in a natural language format;
performing a first embedding operation on the received mission to generate a first vector representation of the received mission;
selecting, from a pool of tasks, a first task that is to be performed by the agent when performing the mission;
performing a second embedding operation on the first task to generate a second vector representation of the first task;
performing a third embedding operation to generate a third vector representation of an order that the first task is to be performed by agent when performing the mission;
concatenating the first, second, and third vector representations to generate a concatenated vector; and
generating, by a machine learning (ML) model, based on the concatenated vector, a task plan that lists the first task in the order that the first task is to be performed by the agent when performing the mission, wherein the task plan also lists one or more additional tasks and the order that the one or more additional tasks are to be performed by the agent when performing the mission.

2. The method of claim 1, further comprising:
selecting, from the pool of tasks, a second task that is to be performed by the agent when performing the mission;
performing a fourth embedding operation on the second task to generate a fourth vector representation of the second task;
performing a fifth embedding operation to generate a fifth vector representation of an order that the second task is to be performed by agent when performing the mission; and
concatenating the first, fourth, and fifth vector representations to generate a second concatenated vector,
wherein the ML model, based on the second concatenated vector, lists in the task plan the second task in the order that the second task is to be performed by the agent when performing the mission, the second task being one of the one or more additional tasks.

3. The method of claim 1, further comprising:
performing, by the agent, the mission by performing all the tasks listed in the task plan in the order that the tasks are listed in the task plan.

4. The method of claim 1, further comprising:
compressing the first vector representation of the received mission to generate a reduced first vector representation.

5. The method of claim 1, wherein the ML model is configured to be trained using a supervised reinforcement learning process.

6. The method of claim 1, wherein the ML model is a Deep Q-Network (DQN) model.

7. The method of claim 1, wherein the first embedding operation is performed by a large language model.

8. The method of claim 1, wherein at least one of the second and third embedding operations is a one-hot encoding operation.

9. The method of claim 1, wherein the ML model ceases to generate the task plan upon receiving a null task.

10. The method of claim 1, wherein the ML model ceases to generate the task plan when a number of tasks including the first task and the one or more additional tasks listed in the task plan reaches a maximum length needed to perform the mission.

11. A non-transitory storage medium having stored therein instructions that are executable by one or more hardware processors to perform operations comprising:
receiving a mission that defines an action that is to be performed by an agent on behalf of a user, the mission being received in a natural language format;
performing a first embedding operation on the received mission to generate a first vector representation of the received mission;
selecting, from a pool of tasks, a first task that is to be performed by the agent when performing the mission;
performing a second embedding operation on the first task to generate a second vector representation of the first task;
performing a third embedding operation to generate a third vector representation of an order that the first task is to be performed by agent when performing the mission;
concatenating the first, second, and third vector representations to generate a concatenated vector; and
generating, by a machine learning (ML) model, based on the concatenated vector, a task plan that lists the first task in the order that the first task is to be performed by the agent when performing the mission, wherein the task plan also lists one or more additional tasks and the order that the one or more additional tasks are to be performed by the agent when performing the mission.

12. The non-transitory storage medium of claim 11, the operations further comprising:
selecting, from the pool of tasks, a second task that is to be performed by the agent when performing the mission;
performing a fourth embedding operation on the second task to generate a fourth vector representation of the second task;
performing a fifth embedding operation to generate a fifth vector representation of an order that the second task is to be performed by agent when performing the mission; and
concatenating the first, fourth, and fifth vector representations to generate a second concatenated vector,
wherein the ML model, based on the second concatenated vector, lists in the task plan the second task in the order that the second task is to be performed by the agent when performing the mission, the second task being one of the one or more additional tasks.

13. The non-transitory storage medium of claim 11, the operations further comprising:
performing, by the agent, the mission by performing all the tasks listed in the task plan in the order that the tasks are listed in the task plan.

14. The non-transitory storage medium of claim 11, the operations further comprising:
compressing the first vector representation of the received mission to generate a reduced first vector representation.

15. The non-transitory storage medium of claim 11, wherein the ML model is configured to be trained using a supervised reinforcement learning process.

16. The non-transitory storage medium of claim 11, wherein the ML model is a Deep Q-Network (DQN) model.

17. The non-transitory storage medium of claim 11, wherein the first embedding operation is performed by a large language model.

18. The non-transitory storage medium of claim 11, wherein at least one of the second and third embedding operations is a one-hot encoding operation.

19. The non-transitory storage medium of claim 11, wherein the ML model ceases to generate the task plan upon receiving a null task.

20. The non-transitory storage medium of claim 11, wherein the ML model ceases to generate the task plan when a number of tasks including the first task and the one or more additional tasks listed in the task plan reaches a maximum length needed to perform the mission.
